(19) United States
(12) Patent Application Publication
(10) Pub. No.: US 2019/0147271 A1
(43) Pub. Date: May 16, 2019

(54) DRIVER DETERMINATION APPARATUS AND DRIVER STATE DETERMINATION APPARATUS INCLUDING DRIVER DETERMINATION APPARATUS, METHOD FOR DRIVER DETERMINATION AND DRIVER STATE DETERMINATION, AND RECORDING MEDIUM

(71) Applicants: OMRON Corporation, Kyoto-shi (JP); OMRON Automotive Electronics Co. Ltd., Komaki-shi (JP)

(72) Inventors: Masato TANAKA, Kizugawa-shi (JP); Yoshio MATSUURA, Kasugai-shi (JP); Keisuke YOKOTA, Kasugai-shi (JP)

(73) Assignees: OMRON Corporation, Kyoto-shi (JP); OMRON Automotive Electronics Co. Ltd., Komaki-shi (JP)

(21) Appl. No.: 16/179,974

(22) Filed: Nov. 4, 2018

(30) Foreign Application Priority Data
Nov. 15, 2017 (JP) 2017-219796

(51) Int. Cl. G06K 9/00; B60W 40/09; G06F 3/01

(52) U.S. Cl. CPC G06K 9/00845; B60W 2040/0809; G06F 3/013; B60W 40/09

(57) ABSTRACT

A driver driving a vehicle is easily determined. A first determiner compares first statistical information, which is statistical information about a retention direction in which a driver looking straight ahead retains his or her face or gaze with respect to a forward direction of a vehicle calculated by a first calculator, from first sensing data output from a first sensor and including an image of a driver of a vehicle and stored in a storage, with second statistical information, which is statistical information about the retention direction for the current vehicle driver calculated similarly by the first calculator, and determines, when finding first statistical information approximate to the second statistical information, the current vehicle driver as a driver associated with the approximate first statistical information.

### CROSS-REFERENCE TO RELATED APPLICATION

This application claims priority to Japanese Patent Application No. 2017-219796 filed on Nov. 15, 2017, the entire disclosure of which is incorporated herein by reference.

### FIELD

Embodiments of the present invention relate to, for example, a driver determination apparatus that determines the driver of a vehicle, a driver state determination apparatus including the driver determination apparatus, a method for such determination, and a recording medium having a program for such determination recorded thereon.

### BACKGROUND

Nowadays, vehicles such as automobiles incorporate various apparatuses that assist the driver while the vehicle is traveling. One known example is a distracted driving determination apparatus that detects the face or gaze direction of the driver to determine whether the driver is engaging in distracted driving. The apparatus generates an alert to the driver engaging in distracted driving. Typically, when the face or gaze direction of the driver deviates from the forward direction by a predetermined angle or more, the driver is determined to be engaging in distracted driving. However, the forward direction of the driver may differ from the forward direction of the vehicle. Individual drivers have different forward directions. More specifically, the directions in which drivers looking straight ahead retain their faces or gazes are known to differ by an angle of a few to a dozen degrees depending on each individual driver.

For example, Patent Literature 1 describes a distracted driving determination apparatus that changes the criterion value for detecting distracted driving in accordance with the frequency ratio between detected distracted driving and undetected distracted driving. This apparatus sets the criterion value appropriate for each driver to correct individual differences, and determines distracted driving accurately without being affected by differences between individual drivers.

### CITATION LIST

### Patent Literature

Patent Literature 1: Japanese Unexamined Patent Application Publication No. 8-207617

### SUMMARY

### Technical Problem

The technique described in Patent Literature 1 may correct differences between individuals by changing the criterion value for detecting distracted driving depending on each individual. However, the technique does not identify individuals in correcting such differences as appropriate. Thus, when the vehicle driver is replaced, the unchanged criterion value for detecting distracted driving appropriate for the previous driver may cause inaccurate determination of distracted driving. In addition, an appropriate criterion value for detecting distracted driving may vary even for the same driver depending on his or her physical conditions and the length of the driving time for the day.

Desirably, the criterion value may be changed in accordance with each driver, and the driver or the driver state may be identified easily. A state change in the same driver may be regarded as a replacement with a different driver.

In response to the above issue, one or more aspects of the present invention are directed to a driver determination apparatus that can easily determine the driver driving a vehicle, a driver state determination apparatus including the driver determination apparatus, a method for such determination, and a recording medium having a program for such determination recorded thereon.

### Solution to Problem

A driver determination apparatus according to a first aspect of the present invention includes a first calculator that calculates first statistical information based on first sensing data output from a first sensor and including an image of a driver of a vehicle, a storage that stores the calculated first statistical information with an identifier associated with the driver, and a first determiner that compares the first statistical information stored in the storage with second statistical information calculated by the first calculator based on first sensing data output from the first sensor and including an image of a current driver of the vehicle, and determines, when finding first statistical information approximate to the second statistical information in the storage, the current vehicle driver as a driver associated with the approximate first statistical information. The first statistical information is statistical information about a retention direction in which the driver looking straight ahead retains a face or a gaze with respect to a forward direction of the vehicle. The second statistical information is statistical information about the retention direction for the current vehicle driver.

The driver determination apparatus according to the first aspect causes the first calculator to calculate the first statistical information about each driver and stores the calculated first statistical information into the storage. The first calculator similarly calculates second statistical information about the current driver. The first determiner compares the calculated second statistical information with the stored first statistical information. When first statistical information approximate to the second statistical information is found in the storage, the first determiner determines the current vehicle driver to be the driver associated with the approximate first statistical information. This structure can easily determine the driver currently driving the vehicle when the driver has the first statistical information already calculated in previous determination.

A driver determination apparatus according to a second aspect of the present invention is the apparatus according to the first aspect further including a second determiner that determines a possibility of a change of the current vehicle driver based on the first sensing data or second sensing data. The second sensing data is output from a second sensor and indicates a vehicle state. The first calculator starts calculating the second statistical information when the second determiner detects a possibility of a driver change.

In the apparatus according to the second aspect, the second determiner determines the possibility of a driver change based on the first or second sensing data. When the second determiner detects the possibility of a driver change, the first calculator starts calculating the second statistical information. For example, the second determiner detects the possibility of a driver change by detecting the complete stop of the vehicle based on the sensing data from a speed sensor that is the second sensor and determining that the vehicle has entered the parking state based on the sensing data from a gear selector sensor and/or a parking brake sensor. In addition, for example, the driver may disappear temporarily from a monitoring image and then appear in a monitoring image again, or detection of the face or the gaze of the driver based on the first sensing data may be temporarily disabled and then enabled again. When the second determiner detects such cases based on the first sensing data from a driver camera that is the first sensor, the second determiner detects the possibility of a driver change. Thus, the possibility of a driver change can be easily determined based on the first or second sensing data. When the possibility of a driver change is detected, the second statistical information is calculated, and the first determiner determines the driver based on the calculation result. Thus, any new driver who has replaced the previous driver can be readily determined immediately after the start of driving.

A driver determination apparatus according to a third aspect of the present invention is the apparatus according to the first or second aspect in which, when finding no first statistical information approximate to the second statistical information after a predetermined number of second statistical information calculations performed by the first calculator, the first determiner stores the second statistical information into the storage as first statistical information associated with a new driver.

In the apparatus according to the third aspect, after a predetermined number of second statistical information calculations, first statistical information approximate to the second statistical information may not be found. In this case, the first determiner stores the calculated second statistical information into the storage as first statistical information about a new driver. Thus, the first statistical information about the new driver can be added.

A driver determination apparatus according to a fourth aspect of the present invention is the apparatus according to any one of the first to third aspects in which the first calculator determines the retention direction of the driver based on the first sensing data. The first statistical information and the second statistical information are averages and deviations of the determined retention direction during a predetermined period.

In the apparatus according to the fourth aspect, the first calculator determines, based on the first sensing data, the retention direction in which the driver looking straight ahead retains a face or a gaze with respect to the forward direction of the vehicle. The first calculator calculates statistical information about the retention direction, for example, the average and the deviation for the retention direction as first and second statistical information. Thus, the apparatus can easily determine the driver currently driving the vehicle based on the statistical information without complicated personal authentication processing such as face recognition, or a specific operation by the driver such as self-reporting of a driver change. With no personal authentication processing, this structure may eliminate the need for higher program security level.

A driver state determination apparatus according to a fifth aspect of the present invention includes the driver determination apparatus according to any one of the first, third, and fourth aspects, a second calculator that calculates new first statistical information based on the first statistical information stored in the storage and the first sensing data, a third determiner that determines a state of the driver based on the first sensing data and the new first statistical information calculated by the second calculator, and an output unit that outputs a determination result from the third determiner to the driver. When a driver determined by the first determiner is identical to a driver having the first statistical information calculated by the second calculator, the second calculator continues the new first statistical information calculation. When the driver determined by the first determiner differs from the driver having the first statistical information calculated by the second calculator, the second calculator switches a target of the new first statistical information calculation to the first statistical information about the determined driver stored in the storage.

In the apparatus according to the fifth aspect, the second calculator calculates new first statistical information based on the first statistical information stored in the storage and the first sensing data. The third determiner determines the driver state based on the first sensing data and the new first statistical information.

The output unit outputs the determination result to the driver. When the driver determined by the first determiner in the driver state determination apparatus is the same as the driver having the first statistical information calculated by the second calculator, the second calculator will continue to calculate new first statistical information. Thus, when the driver associated with the new first statistical information calculated by the second calculator is the current driver, the new first statistical information calculation continues, and the driver state may be determined using the accurate first statistical information that is also based on the first statistical information stored in the storage. When the driver determined by the first determiner in the driver state determination apparatus differs from the driver having the first statistical information calculated by the second calculator, the second calculator will switch the target of the new first statistical information calculation to the first statistical information about the determined driver stored in the storage. The switching prevents the new first statistical information that has been calculated up until then from being used in driver state determination. This is because the new first statistical information that has been calculated up until then is based on the first statistical information about another driver stored in the storage, and thus is inappropriate for the current driver different from the driver associated with the new first statistical information calculated by the second calculator. The second calculator then switches the target of the new first statistical information calculation to the first statistical information about the determined driver stored in the storage, and calculates new first statistical information associated with the current driver. The calculated accurate first statistical information can be used to determine the driver state. This structure performs accurate driver state determination irrespective of differences between individual drivers.

A driver state determination apparatus according to a sixth aspect of the present invention is the apparatus according to the fifth aspect in which the driver determination apparatus further includes a second determiner that determines a possibility of a change of the current vehicle driver based on the first sensing data or second sensing data. The second sensing data is output from a second sensor and indicates a vehicle state. The first calculator starts calculating the second statistical information when the second determiner detects a possibility of a driver change. The second calculator stores the new first statistical information into the storage when the second determiner detects a possibility of a driver change.

In the apparatus according to the sixth aspect, the second determiner determines the possibility of a driver change based on the first or second sensing data. When the second determiner detects the possibility of a driver change, the first calculator starts calculating the second statistical information. Thus, the possibility of a driver change can be easily determined based on the first or second sensing data. When the possibility of a driver change is detected, the second statistical information is calculated, and the first determiner determines the driver based on the calculation result. Thus, any new driver who has replaced the previous driver can be readily identified immediately after the start of driving. When the second determiner detects the possibility of a driver change, the second calculator stores the new first statistical information that has been calculated up until then into the storage. This allows the new first statistical information with its accuracy increased through repetitive calculations to be used for driver determination performed by the first determiner.

A driver state determination apparatus according to a seventh aspect of the present invention is the apparatus according to the fifth or sixth aspect in which, when the first determiner finds no first statistical information approximate to the second statistical information after a predetermined number of second statistical information calculations performed by the first calculator, the first calculator stores the second statistical information into the storage as first statistical information associated with a new driver, and stops the second statistical information calculation. The second calculator switches a target of the new first statistical information calculation to the first statistical information about the new driver stored into the storage by the first calculator.

In the apparatus according to the seventh aspect, after a predetermined number of second statistical information calculations, first statistical information approximate to the second statistical information may not be found. In this case, the second statistical information calculated by the first calculator is stored into the storage as first statistical information about a new driver. The second calculator switches the target of the new first statistical information calculation to the first statistical information about the new driver stored in the storage. Thus, the first statistical information about the new driver can be added before the start of driver state determination.

A driver state determination apparatus according to an eighth aspect of the present invention is the apparatus according to any one of the fifth to seventh aspects in which the first calculator calculates the second statistical information in parallel with the new first statistical information calculation performed by the second calculator. The first calculator stops the second statistical information calculation when the first determiner determines the current vehicle driver as a driver associated with the approximate first statistical information.

In the apparatus according to the eighth aspect, the first calculator calculates second statistical information in parallel with the new first statistical information calculation performed by the second calculator, and stops the calculation when the first determiner identifies the current driver of the vehicle. Thus, the first calculator can calculate second statistical information as appropriate.

A driver determination method according to a ninth aspect of the present invention is implemented by a driver determination apparatus for determining a driver. The method includes calculating, with the driver determination apparatus, first statistical information based on first sensing data output from a first sensor and including an image of a driver of a vehicle, storing, with the driver determination apparatus, the calculated first statistical information with an identifier associated with the driver, calculating, with the driver determination apparatus, second statistical information based on first sensing data output from the first sensor and including an image of a current driver of the vehicle, and comparing, with the driver determination apparatus, the calculated second statistical information with the stored first statistical information, and when first statistical information approximate to the second statistical information is stored, determining the current vehicle driver as a driver associated with the approximate first statistical information. The first statistical information is statistical information about a retention direction in which the driver looking straight ahead retains a face or a gaze with respect to a forward direction of the vehicle. The second statistical information is statistical information about the retention direction for the current vehicle driver.

The method according to the ninth aspect can easily identify, in the same manner as the apparatus according to the first aspect, the driver currently driving the vehicle when the driver has the first statistical information already calculated in previous determination.

A driver state determination method according to a tenth aspect of the present invention is implemented by a driver state determination apparatus and includes the driver determination method according to the ninth aspect. The driver state determination method includes calculating, with the driver state determination apparatus, new first statistical information based on the stored first statistical information and the first sensing data, determining, with the driver state determination apparatus, a state of the driver based on the calculated new first statistical information, and outputting, with the driver state determination apparatus, a determination result of the driver state to the driver. When a driver determined in determining the current vehicle driver as the driver associated with the approximate first statistical information is identical to a driver having the new first statistical information calculated, calculating the new first statistical information includes continuing the new first statistical information calculation. When the determined driver differs from the driver having the new first statistical information calculated, calculating the new first statistical information includes switching a target of the new first statistical information calculation to the stored first statistical information about the determined driver.

The method according to the tenth aspect uses, in the same manner as the apparatus according to the fifth aspect, accurate first statistical information to determine the driver state, and performs accurate driver state determination irrespective of differences between individual drivers. Additionally, the method prevents first statistical information inappropriate for the current driver from being used for driver state determination.

A non-transitory recording medium according to an eleventh aspect of the present invention records a driver determination program causing a computer to function as the units included in the driver determination apparatus according to any one of the first to fourth aspects.

The non-transitory recording medium according to the eleventh aspect allows a computer to implement the first to fourth aspects.

A non-transitory recording medium according to a twelfth aspect of the present invention records a driver state determination program causing a computer to function as the units included in the driver state determination apparatus according to any one of the fifth to eighth aspects.

The non-transitory recording medium according to the twelfth aspect allows a computer to implement the fifth to eighth aspects.

### Advantageous Effects

The aspects of the present invention provide a driver determination apparatus that can easily determine the driver driving the vehicle, a driver state determination apparatus including the driver determination apparatus, a method for such determination, and a recording medium having a program for such determination recorded thereon.

### BRIEF DESCRIPTION OF THE DRAWINGS

FIG. 1 is a block diagram showing an example use of a driver determination apparatus and a driver state determination apparatus according to one embodiment of the present invention.

FIG. 2 is a block diagram of a driver state determination system including the driver determination apparatus and the driver state determination apparatus according to the embodiment of the invention.

FIG. 3A is a diagram showing an example nonvolatile statistic table provided in a learning data storage shown in FIG. 2.

FIG. 3B is a diagram showing an example volatile statistic table provided in the learning data storage shown in FIG. 2.

FIG. 3C is a diagram showing another example volatile statistic table provided in the learning data storage shown in FIG. 2.

FIG. 3D is a diagram showing an example nonvolatile statistic table to which learned second statistical values have been added as new first statistical values.

FIG. 4 is a flowchart showing the procedure and processing performed by the driver state determination system shown in FIG. 2.

FIG. 5 is a time chart showing an example of statistic learning that follows the procedure in the driver state determination system shown in FIG. 2.

### DETAILED DESCRIPTION

Embodiments of the present invention will now be described with reference to the drawings.

### Example Use

One example use of a driver determination apparatus and a driver state determination apparatus according to an embodiment of the present invention will now be described.

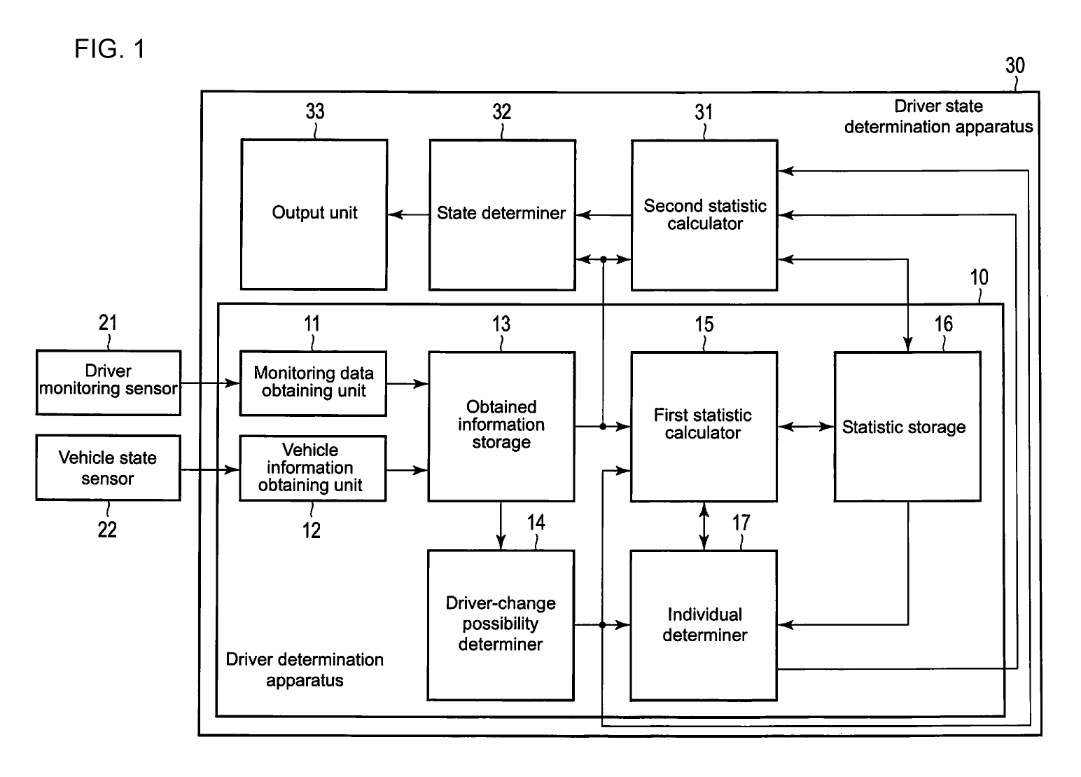

FIG. 1 schematically shows the driver determination apparatus and the driver state determination apparatus in this example use.

The driver determination apparatus 10 includes a monitoring data obtaining unit 11, a vehicle information obtaining unit 12, and an obtained information storage 13 as storage processing units, a driver-change possibility determiner 14 as a second determiner, a first statistic calculator 15 as a first calculator, a statistic storage 16 as a storage, and an individual determiner 17 as a first determiner. The driver determination apparatus 10 is connected to a driver monitoring sensor 21 that serves as a first sensor and one or more vehicle state sensors 22 that each serves as a second sensor. The driver state determination apparatus 30 includes the driver determination apparatus 10, a second statistic calculator 31 as a second calculator, a state determiner 32 as a third determiner, and an output unit 33.

The monitoring data obtaining unit 11 obtains first sensing data from the driver monitoring sensor 21 installed at a predetermined position in a vehicle with respect to the driver. The driver monitoring sensor 21 serves as a first sensor to detect acts of the driver and associated information including, for example, the retention direction in which the driver looking straight ahead retains his or her face or gaze with respect to the forward direction of the vehicle. For example, the driver monitoring sensor 21 is installed at a location for capturing an image of the face of the driver. The driver monitoring sensor 21 may be a camera placed, for example, on the dashboard, at the center of the steering wheel, beside the speed meter, or on a front pillar to capture an image of the upper part of the driver body including the face. This camera may be a still camera that captures multiple still images of the driver per second or a video camera that captures moving images of the driver. The monitoring data obtaining unit 11 digitizes image signals from the camera and obtains the digitized image signals as the first sensing data including driver images. The monitoring data obtaining unit 11 stores the obtained first sensing data into the obtained information storage 13.

The obtained information storage 13 includes, as storage media, a read-write nonvolatile memory such as a hard disk drive (HDD) or a solid state drive (SSD), and a volatile memory such as a random-access memory (RAM).

The vehicle information obtaining unit 12 obtains vehicle information from the vehicle state sensors 22 each serving as the second sensor installed at a predetermined position of the vehicle. Each vehicle state sensor 22 detects information to be used for the driver-change possibility determiner 14 to determine whether the driver has been changed. Drivers may be changed usually in a parking state, in which the vehicle is completely stopped. The vehicle state sensors 22 may thus include a speed sensor for detecting the vehicle speed, a parking brake sensor for detecting the state of the parking brake, and a gear selector sensor for detecting the parking position of the gear selector in an automatic transmission car. As described above, the vehicle state sensors 22 may be one or more sensors. The vehicle information obtaining unit 12 digitizes the information detected by each vehicle state sensor 22 and obtains the digitized information as second sensing data indicating the vehicle state. Each vehicle state sensor 22 stores the obtained second sensing data into the obtained information storage 13.

The driver-change possibility determiner 14 determines the possibility of a driver change based on the vehicle information stored in the obtained information storage 13. When, for example, the vehicle completely stops and enters a parking state, the driver-change possibility determiner 14 detects the possibility of a driver change. The driver-change possibility determiner 14 may also determine the possibility of a driver change based on the first sensing data stored in the obtained information storage 13. For example, the driver-change possibility determiner 14 may once fail to detect the driver temporarily and then detect the driver again. In such a case, the driver-change possibility determiner 14 detects the possibility of a driver change.

The statistic storage 16 includes, as storage media, a combination of a read-write nonvolatile memory such as an HDD or an SSD and a volatile memory such as a RAM. The nonvolatile memory in the statistic storage 16 stores driver identifiers together with first statistical information about acts of each driver and associated information including, for example, the retention direction in which the driver looking straight ahead retains the face or gaze with respect to the forward direction of the vehicle. The first statistical information includes, for example, the average and the deviation for the retention direction of the face or gaze of the driver. The first statistical information has been calculated by the first statistic calculator 15. The volatile memory in the statistic storage 16 temporarily stores second statistical information also calculated in the first statistic calculator 15 and new first statistical information calculated in the second statistic calculator 31. The second statistical information and the new first statistical information will be described later.

During operation of the engine and/or the motor serving as the vehicle power system, the first statistic calculator 15 detects, from the first sensing data including driver images and stored in the obtained information storage 13, the retention direction in which the driver looking straight ahead retains the face or gaze, for example, with respect to the forward direction of the vehicle. In every predetermined period after the driver-change possibility determiner 14 detects the possibility of a driver change, the first statistic calculator 15 repeatedly calculates second statistical information including the average and the deviation for the retention direction of the face or gaze of the driver during the predetermined period. The first statistic calculator 15 then stores the second statistical information into the volatile memory in the statistic storage 16 to update the existing information in the memory. In this manner, second statistical information is learned. The second statistical information may also be calculated as, for example, the average or the weighted average of the statistical information calculated based on the first sensing data during the predetermined period and the second statistical information temporarily stored in the volatile memory in the statistic storage 16.

The second statistical information may be calculated under a condition set using, for example, the vehicle speed, the steering angle, and the operation of a direction indicator. For example, with the condition that the vehicle is traveling straight at a speed of 60 km or more per hour with no direction indicator blinking, the average and the deviation for the face or gaze direction of the driver expected to be looking straight ahead are calculated. More specifically, the average or the deviation for the face or gaze direction of the driver is not calculated when the driver is not looking straight ahead. This guarantees the accuracy of the obtained second statistical information.

When the driver-change possibility determiner 14 detects the possibility of a driver change, the individual determiner 17 identifies the current driver by comparing the second statistical information calculated by the first statistic calculator 15 and stored in the volatile memory in the statistic storage 16, with the first statistical information about each driver stored in the nonvolatile memory in the statistic storage 16. The second statistical information includes, for example, the average and the deviation for the retention direction in which the current driver looking straight ahead retains the face or gaze with respect to the forward direction of the vehicle. The first statistical information includes, for example, the average and the deviation for the retention direction of the face or gaze of each driver. More specifically, when first statistical information approximate to the second statistical information is found in the nonvolatile memory in the statistic storage 16, the individual determiner 17 determines the current driver of the vehicle to be the driver associated with the approximate first statistical information. When the individual determiner 17 identifies the current driver in .this manner, the first statistic calculator 15 stops the second statistical information calculation.

After a predetermined number of second statistical information calculations performed by the first statistic calculator 15, first statistical information approximate to the second statistical information may not be found in the nonvolatile memory in the statistic storage 16. In this case, the current driver corresponds to no stored driver data. The individual determiner 17 then stores the second statistical information calculated by the first statistic calculator 15 and stored in the volatile memory in the statistic storage 16, into the nonvolatile memory in the statistic storage 16 as first statistical information associated with a new driver. The first statistic calculator 15 stops the second statistical information calculation.

During operation of the engine and/or the motor serving as the vehicle power system, the second statistic calculator 31 in the driver state determination apparatus 30 detects, from the first sensing data including driver images and stored in the obtained information storage 13, the retention direction in which the driver looking straight ahead retains the face or gaze, for example, with respect to the forward direction of the vehicle. In every predetermined period, the second statistic calculator 31 calculates statistical information including the average and the deviation for the retention direction of the face or gaze of the driver during the predetermined period as new first statistical information. The second statistic calculator 31 then stores the new first statistical information into the volatile memory in the statistic storage 16 to update the existing information in the memory. In this manner, new first statistical information is learned. In this manner, the second statistic calculator 31 continues to repeatedly calculate (learn) new first statistical information during operation of the engine and/or the motor serving as the vehicle power system. When the possibility of a driver change is detected, the first statistic calculator 15 will continue to calculate second statistical information in parallel with the new first statistical information calculation (learning) by the second statistic calculator 31.

The second statistic calculator 31 calculates new first statistical information as, for example, the average or the weighted average of the statistical information calculated based on the first sensing data during the predetermined period, the first statistical information stored in the nonvolatile memory in the statistic storage 16, and the new first statistical information temporarily stored in the volatile memory in the statistic storage 16. The new first statistical information may also be calculated under a condition set using, for example, the vehicle speed, the steering angle, and the operation of the direction indicator. For example, with the condition that the vehicle is traveling straight at a speed of 60 km or more per hour with no direction indicator blinking, the average and the deviation for the face or gaze direction of the driver expected to be looking straight ahead are calculated. More specifically, the average or the deviation for the face or gaze direction of the driver is not calculated when the driver is not looking straight ahead. This guarantees the accuracy of the obtained new first statistical information.

In addition, when the driver-change possibility determiner 14 detects the possibility of a driver change, the second statistic calculator 31 stores the new first statistical information calculated immediately before the detection and temporarily stored in the volatile memory in the statistic storage 16, into the nonvolatile memory in the statistic storage 16 as the first statistical information about the driver. In this manner, the nonvolatile memory in the statistic storage 16 successively stores first statistical information about each driver, for example, the average and the deviation for the retention direction in which the driver looking straight ahead retains the face or gaze with respect to the forward direction of the vehicle.

After a predetermined number of second statistical information calculations performed by the first statistic calculator 15, first statistical information approximate to the second statistical information may not be found in the nonvolatile memory in the statistic storage 16. In this case, the current driver corresponds to no stored driver data. The individual determiner 17 then stores the second statistical information calculated by the first statistic calculator 15 and stored in the volatile memory in the statistic storage 16, into the nonvolatile memory in the statistic storage 16 as first statistical information associated with a new driver, as described above. The second statistic calculator 31 also switches the target of the new first statistical information calculation to the first statistical information about the new driver stored in the volatile memory in the statistic storage 16.

The state determiner 32 determines the state of the driver based on the first sensing data including driver images and stored in the obtained information storage 13, and the new first statistical information calculated by the second statistic calculator 31. For example, the state determiner 32 detects the face or gaze direction of the driver from the first sensing data, and corrects the detected direction with the calculated new first statistical information, or more specifically, the average of the retention direction in which the driver looking straight ahead retains the face or gaze with respect to the forward direction of the vehicle. The state determiner 32 then compares the corrected direction with a predetermined determination criterion value. The state determiner 32 may correct the face or gaze direction of the driver detected from the first sensing data with the calculated new first statistical information, and compare the corrected direction with the determination criterion value set at a fixed value. The state determiner 32 determines the state of the driver based on the comparison. For example, the state determiner 32 determines whether the driver is engaging in distracted driving.

The state determiner 32 may determine whether to determine the state of the driver or whether to output a determination result based on the second sensing data indicating the vehicle state and stored in the obtained information storage 13, for example, the sensing data from a steering sensor or a direction indicator sensor. This prevents an alert from being generated against an act of the driver for safety checking in rounding a curve on a road, turning right or left, or changing lanes. Such an act may be similar to distracted driving and erroneously determined to be distracted driving.

The output unit 33 outputs the determination result from the state determiner 32 to the driver. The output unit 33 includes, for example, a speaker and an alert indicator lamp, and outputs the determination result from the state determiner 32 to the driver by emitting an alert sound or lighting the alert lamp. The output unit 33 may be one of the speaker and the alert indicator lamp. The alert sound and the alert indication may be implemented by a sound output function and an image display function of a navigation system included in the vehicle. In this case, the output unit 33 may output the state determination result information indicating the determination result from the state determiner 32 to the navigation system.

The driver determination apparatus 10 with the above configuration uses the first statistic calculator 15 to calculate first statistical information about each driver, and stores the calculated first statistical information into the nonvolatile memory included in the statistic storage 16 together with the identifier identifying each driver. The first statistic calculator 15 similarly calculates second statistical information about the current driver. The individual determiner 17 compares the calculated second statistical information with the first statistical information stored in the nonvolatile memory. When first statistical information approximate to the second statistical information is found in the nonvolatile memory, the individual determiner 17 determines the current vehicle driver to be the driver associated with the approximate first statistical information. More specifically, the individual determiner 17 compares the calculated second statistical information with the first statistical information about each driver stored in the statistic storage 16 in a nonvolatile manner, and this comparison enables the current driver to be identified as one of the registered drivers. This structure can easily identify the driver currently driving the vehicle when the driver has the first statistical information previously calculated.

In the driver determination apparatus 10, the driver-change possibility determiner 14 determines the possibility of a driver change based on the first or second sensing data. When the driver-change possibility determiner 14 detects the possibility of a driver change, the first statistic calculator 15 starts calculating the second statistical information. Thus, the possibility of a driver change can be easily determined based on the first or second sensing data. When the possibility of a driver change is detected, the second statistical information is calculated, and the individual determiner 17 determines the driver based on the calculation result. When the individual determiner 17 determines the current driver of the vehicle to be the driver associated with the approximate first statistical information, and further determines that the driver associated with the approximate first statistical information is the same as the driver identified before the driver-change possibility determiner 14 detects the possibility of a driver change, the individual determiner 17 determines that the driver has not been replaced. When the determined driver differs from the driver identified before the driver-change possibility determiner 14 detects the possibility of a driver change, the individual determiner 17 determines that the previous driver has been replaced, and easily identifies the current driver as one of the drivers. Thus, any new driver who has replaced the previous driver can be readily identified immediately after the start of driving.

In the driver determination apparatus 10, after a predetermined number of second statistical information calculations, first statistical information approximate to the second statistical information may not be found. In this case, the individual determiner 17 stores the calculated second statistical information into the nonvolatile memory in the statistic storage 16 as first statistical information about a new driver. Thus, the first statistical information about the new driver can be added.

In the driver determination apparatus 10, the first statistic calculator 15 determines, based on the first sensing data, the retention direction in which the driver looking straight ahead retains the face or gaze with respect to the forward direction of the vehicle. The first statistic calculator 15 then calculates statistical information about the retention direction of the face or gaze of the driver, for example, the average and the deviation for the retention direction of the face or gaze of the driver as first and second statistical information. Thus, the apparatus can easily determine the driver currently driving the vehicle based on the statistical information without complicated personal authentication processing such as face recognition, or a specific operation by the driver such as self-reporting of a driver change. With no personal authentication processing, this structure may eliminate the need for higher program security level.

In the driver state determination apparatus 30, the second statistic calculator 31 calculates new first statistical information based on the first statistical information stored in the nonvolatile memory in the statistic storage 16 and the first sensing data. The state determiner 32 determines the driver state based on the first sensing data and the new first statistical information. The output unit 33 outputs the determination result to the driver. When the driver determined by the individual determiner 17 is the same as the driver having the first statistical information calculated by the second statistic calculator 31, the second statistic calculator 31 will continue to calculate new first statistical information. In other words, when the driver associated with the new first statistical information calculated by the second statistic calculator 31 is the current driver, the new first statistical information calculation continues. Thus, the driver state determination apparatus 30 determines the driver state using the accurate first statistical information that is also based on the first statistical information stored in the statistic storage 16 about the driver associated with the new first statistical information when the state determiner 32 determines the driver state based on the first sensing data and the new first statistical information.

In contrast, the second statistic calculator 31 in the driver state determination apparatus 30 switches the target of the new first statistical information calculation to the first statistical information about the determined driver stored in the nonvolatile memory in the statistic storage 16 when the driver determined by the individual determiner 17 differs from the driver having the first statistical information calculated by the second statistic calculator 31. The switching prevents the new first statistical information that has been calculated up until then from being used in driver state determination. This is because the new first statistical information that has been calculated up until then is based on the first statistical information about another driver stored in the nonvolatile memory in the statistic storage 16, and thus is inappropriate for the current driver different from the driver associated with the new first statistical information calculated by the second statistic calculator 31. The second statistic calculator 31 thus switches the target of the new first statistical information calculation to the first statistical information about the determined driver stored in the nonvolatile memory in the statistic storage 16, and calculates new first statistical information associated with the current driver. The calculated accurate first statistical information can be used to determine the driver state.

The driver state determination apparatus 30 can determine the driver state using first statistical information associated with each individual driver, and thus achieve accurate driver state determination irrespective of differences between individual drivers.

The driver-change possibility determiner 14 in the driver state determination apparatus 30 determines the possibility of a driver change based on the first or second sensing data. When the driver-change possibility determiner 14 detects the possibility of a driver change, the second statistic calculator 31 stores the new first statistical information that has been calculated up until then into the nonvolatile memory in the statistic storage 16. This allows the new first statistical information with its accuracy increased through repetitive calculations to be used for driver determination by the individual determiner 17.

In the driver state determination apparatus 30, first statistical information approximate to the second statistical information may not be found after a predetermined number of second statistical information calculations. In this case, the second statistical information calculated by the first statistic calculator 15 is stored into the nonvolatile memory in the statistic storage 16 as first statistical information about a new driver. The second statistic calculator 31 switches the target of the new first statistical information calculation to the first statistical information about the new driver stored in the nonvolatile memory in the statistic storage 16. Thus, the first statistical information about the new driver can be added before the start of driver state determination.

The first statistic calculator 15 in the driver state determination apparatus 30 calculates second statistical information in parallel with the new first statistical information calculation by the second statistic calculator 31, and stops the calculation when the individual determiner 17 identifies the current driver of the vehicle. Thus, the first statistic calculator 15 can calculate second statistical information as appropriate.

### One Embodiment

One embodiment of the present invention will now be described. Configuration

### (1) System

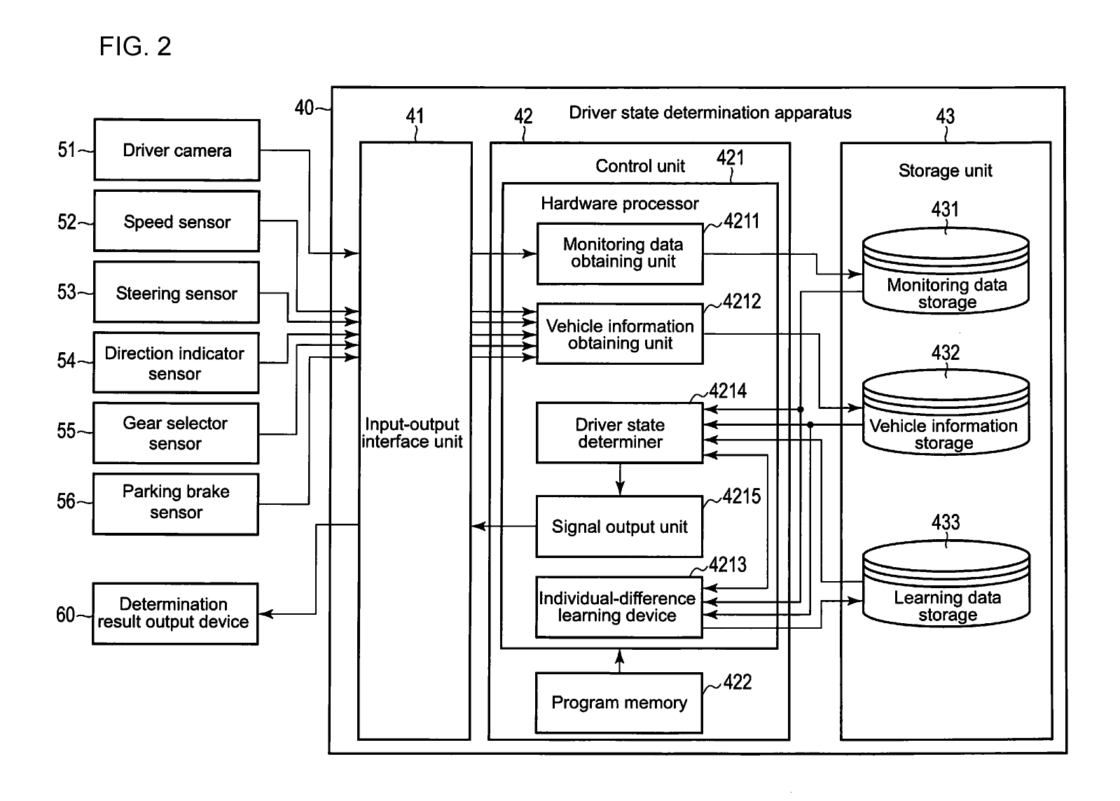

FIG. 2 is a diagram showing an example overall configuration of a driver state determination system including a driver determination apparatus according to an embodiment of the present invention and a driver state determination apparatus including the driver determination apparatus.

The driver state determination system includes a driver state determination apparatus 40 including a driver determination apparatus according to an embodiment, various sensors 51 to 56, and a determination result output device 60.

### (2) Sensors

Sensors used in the present embodiment include, for example, a driver camera 51 serving as a driver monitoring sensor, and a speed sensor 52, a steering sensor 53, a direction indicator sensor 54, a gear selector sensor 55, and a parking brake sensor 56 serving as vehicle state sensors. These are mere examples, and other sensors may also be included.

The driver camera 51 is installed at a location for capturing an image of the face of the driver. The driver camera 51 is a camera placed, for example, on the dashboard, at the center of the steering wheel, beside the speed meter, or on a front pillar to capture an image of the upper part of the body of the driver including the face. The driver camera 51 may be a still camera that captures multiple still images per second or a video camera that captures moving images.

The speed sensor 52 detects the moving speed of the vehicle. The steering sensor 53 detects the steering angle of the steering wheel. The steering sensor 53 may detect a steering operation by a driver or detect the wheel angle changed by a steering operation. The direction indicator sensor 54 detects the operation of the direction indicator. The direction indicator sensor 54 may detect a direction indicator lever operation performed by a driver or detect a blinking control signal to the direction indicator blinking in response to the direction indicator lever operation.

The gear selector sensor 55 detects the parking position of the gear selector in an automatic transmission car. The gear selector sensor 55 may detect a selecting operation by a driver with the gear selector or detect a lighting control signal to the indicator for the selected position. The parking brake sensor 56 detects the state of the parking brake. The parking brake sensor 56 may detect a parking brake lever operation by a driver or detect an activation control signal for activating the parking brake. Both the gear selector sensor 55 and the parking brake sensor 56 may not be included. For example, an automatic transmission vehicle may include the gear selector sensor 55, but may not include the parking brake sensor 56. A manual transmission vehicle may simply include the parking brake sensor 56.

### (3) Driver State Determination Apparatus

The driver state determination apparatus 40 includes a control unit 42, an input-output interface unit 41, and a storage unit 43.

The input-output interface unit 41 receives an image signal output from the driver camera 51, converts the received signal into digital data, and inputs the resulting data in the control unit 42. The input-output interface unit 41 also receives sensing data from each of the speed sensor 52, the steering sensor 53, the direction indicator sensor 54, the gear selector sensor 55, and the parking brake sensor 56, and inputs the data in the control unit 42. The input-output interface unit 41 further converts driver state determination result information output from the control unit 42 into an output control signal and outputs the resulting signal to the determination result output device 60.

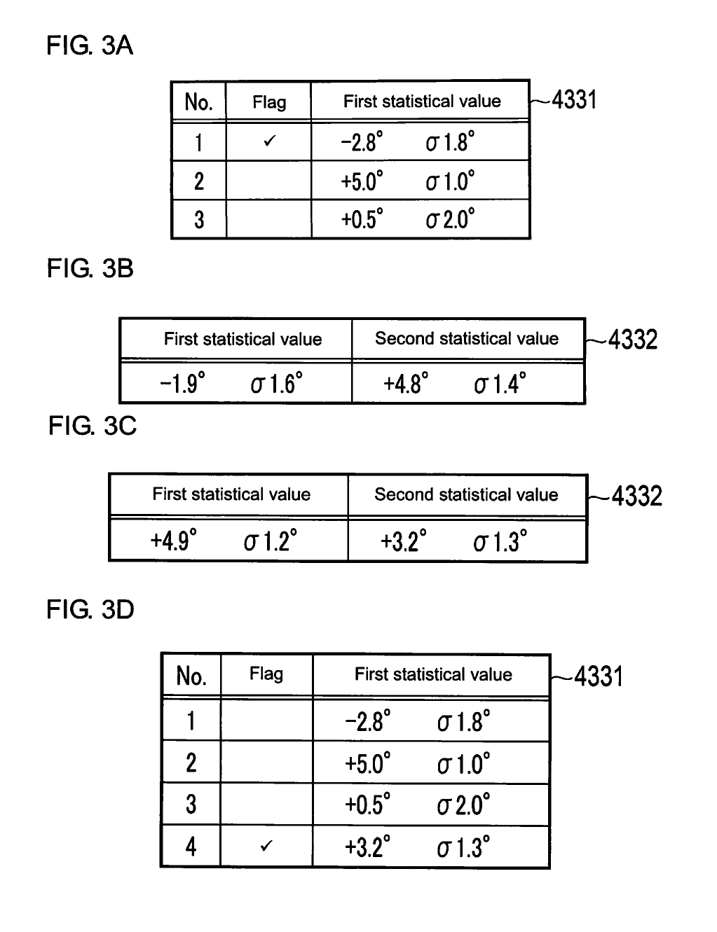

The storage unit 43 includes, as storage media, a read-write nonvolatile memory such as an SSD or an HDD and a volatile memory such as RAM. The storage unit 43 includes, as storage areas used in the present embodiment, monitoring data storage 431 for monitoring data about drivers, vehicle information storage 432 for vehicle states, and learning data storage 433 for learning data that is statistical information for correcting individual differences. The learning data storage 433 has, for example, a nonvolatile statistic table 4331 shown in FIG. 3A storing learning data in a nonvolatile manner and a volatile statistic table 4332 shown in FIG. 3B storing learning data in a volatile manner.

FIG. 3A is a diagram showing an example of the nonvolatile statistic table 4331 provided in the learning data storage 433. In the present embodiment, the nonvolatile statistic table 4331 stores first statistical values together with driver identifiers. The first statistical values are statistical information about each driver previously learned by an individual-difference learning device 4213, such as the average and the deviation for the retention direction in which the driver looking straight ahead retains the face or gaze with respect to the forward direction of the vehicle. The nonvolatile statistic table 4331 additionally stores a driver flag indicating the current driver. In the example shown in FIG. 3A, the nonvolatile statistic table 4331 includes first statistical values about three drivers. More specifically, when the vehicle forward direction is set at 0°, the average of the retention direction of the face or gaze of the driver identified by driver identifier 1 is −2.8°, and the deviation of the retention direction of the face or gaze of the driver is 1.8°. The average of the retention direction of the face or gaze of the driver identified by driver identifier 2 is +5.0°, and the deviation is 1.0°. The average of the retention direction of the face or gaze of the driver identified by driver identifier 3 is +0.5°, and the deviation is 2.0°. The driver flag is set at the current driver identified by driver identifier 1. In this example, lateral deviations from the vehicle forward direction are stored as ±values. However, vertical deviations from the vehicle forward direction may be stored as ±values, or lateral and vertical deviations may also be stored. Additionally, an inclination of the head may be stored. The driver flag may not be included in the nonvolatile statistic table 4331, and information indicating the current driver may be stored in the learning data storage 433 or any other area in a nonvolatile manner.

FIG. 3B is a diagram showing an example of the volatile statistic table 4332 provided in the learning data storage 433. In the present embodiment, the volatile statistic table 4332 temporarily stores first and second statistical values about the current driver being learned by the individual-difference learning device 4213. The first and second statistical values are statistical information such as the average and the deviation for the retention direction in which the driver looking straight ahead retains the face or gaze with respect to the forward direction of the vehicle. As described later, the first statistical values are new first statistical values learned by the individual-difference learning device 4213 based on the retention direction of the face or gaze of the current driver and the first statistical values about the driver for which the driver flag is set in the nonvolatile statistic table 4331 included in the learning data storage 433. As described later, the second statistical values are statistical values learned by the individual-difference learning device 4213 based on the retention direction of the face or gaze of the current driver.

The control unit 42 includes a hardware processor 421 such as a central processing unit (CPU) and a program memory 422. The control unit 42 includes a monitoring data obtaining unit 4211, a vehicle information obtaining unit 4212, the individual-difference learning device 4213, a driver state determiner 4214, and a signal output unit 4215 as software components for implementing the present embodiment. The software components are implemented by the hardware processor 421 executing programs stored in the program memory 422. Each of these software components may be a dedicated hardware component.

The monitoring data obtaining unit 4211 obtains a monitoring image of the driver from the driver camera 51. More specifically, the monitoring data obtaining unit 4211 receives, through the input-output interface unit 41, sensing data that is the digital data representing a driver image signal output from the driver camera 51, and stores the received sensing data into the monitoring data storage 431 in the storage unit 43 as monitoring data for the driver.

The vehicle information obtaining unit 4212 obtains vehicle information from each of the speed sensor 52, the steering sensor 53, the direction indicator sensor 54, the gear selector sensor 55, and the parking brake sensor 56. More specifically, the vehicle information obtaining unit 4212 receives, through the input-output interface unit 41, sensing data output from each of these sensors, and stores the received sensing data into the vehicle information storage 432 in the storage unit 43 as vehicle information.

The individual-difference learning device 4213 learns differences between individual drivers. For example, during operation of the engine and/or the motor serving as the vehicle power system, the individual-difference learning device 4213 calculates statistical information such as the average and the deviation for the retention direction in which the driver looking straight ahead retains the face or gaze with respect to the forward direction of the vehicle in every predetermined period. However, the statistical information is calculated and learned under a condition set using, for example, the vehicle speed, the steering angle, and the operation of the direction indicator. For example, with the condition that the vehicle is traveling straight at a speed of 60 km or more per hour with no direction indicator blinking, the average and the deviation for the face or gaze direction (retention direction) of the driver expected to be looking straight ahead are learned. More specifically, no statistical information is learned from a retention direction when the driver is not looking straight ahead. This guarantees the accuracy of the learning results.

The retention direction in which the driver looking straight ahead retains the face or gaze with respect to the forward direction of the vehicle can be detected by the driver state determiner 4214 based on the monitoring data stored in the monitoring data storage 431.

The individual-difference learning device 4213 then calculates new first statistical values based on the calculated statistical information and the first statistical values temporarily stored in the volatile statistic table 4332 in the learning data storage 433. The temporarily stored first statistical values are, for example, the statistical information such as the average and the deviation for the retention direction in which the driver looking straight ahead retains the face or gaze with respect to the forward direction of the vehicle. The new first statistical values are calculated as, for example, the average or the weighted average of the above learned (calculated) statistical information and the statistical information temporarily stored in the volatile statistic table 4332. The individual-difference learning device 4213 then overwrites the first statistical values temporarily stored in the volatile statistic table 4332 with the calculated new first statistical values. In this manner, the individual-difference learning device 4213 successively learns new first statistical values as new first statistical information in every predetermined period.

When the possibility of a driver change is detected, the individual-difference learning device 4213 calculates the first statistical values as well as second statistical information such as the average and the deviation for the retention direction of the face or gaze of the driver in a predetermined period, for example, in the predetermined period described above, after the possibility is detected. The individual-difference learning device 4213 then stores the calculated second statistical information into the volatile statistic table 4332 as second statistical values to update the existing information in the table. Also in this case, a condition is set using, for example, the vehicle speed, the steering angle, and the operation of the direction indicator as in learning the first statistical values. The average and the deviation for the retention direction of the face or gaze of the driver are calculated under a condition that the driver is expected to be looking straight ahead. In this manner, the individual-difference learning device 4213 learns second statistic values as second statistical information in every predetermined period.

The hardware processor 421 including the individual-difference learning device 4213 starts the operation when the vehicle power system is turned on, and stops the operation when the driving source is turned off.

In addition to the retention direction of the face or gaze of the driver, the driver state determiner 4214 determines the possibility of a driver change. More specifically, the driver state determiner 4214 can determine the possibility of a driver change based on the vehicle information stored in the vehicle information storage 432. For example, the driver state determiner 4214 can detect the possibility of a driver change by detecting the complete stop of the vehicle based on the sensing data from the speed sensor 52 and determining that the vehicle has entered the parking state based on the sensing data from the gear selector sensor 55 and/or the parking brake sensor 56. In some embodiments, the driver state determiner 4214 may detect the possibility of a driver change based on the monitoring data stored in the monitoring data storage 431. For example, the driver state determiner 4214 may detect the possibility of a driver change when the driver disappears temporarily from a monitoring image and then appears in a monitoring image again, or when the detection of the face or gaze of the driver using monitoring data is temporarily disabled and then enabled again. When detecting the possibility of a driver change in this manner, the driver state determiner 4214 outputs a driver change trigger signal to the individual-difference learning device 4213.

In response to the input driver change trigger signal, the individual-difference learning device 4213 determines the new first statistical values calculated immediately before the input and temporarily stored in the volatile statistic table 4332 to be the first statistical values about the driver. The individual-difference learning device 4213 overwrites, with the new first statistical values, the first statistical values about the driver for which the driver flag is set in the nonvolatile statistic table 4331 included in the learning data storage 433. In this manner, the nonvolatile statistic table 4331 successively stores first statistical values about each driver, for example, the average and the deviation for the retention direction of the face or gaze of the driver. In this manner, the individual-difference learning device 4213 successively learns first statistical values.

The driver state determiner 4214 determines the state of the driver. For example, the driver state determiner 4214 identifies the current driver as one of the drivers in the nonvolatile statistic table 4331 by comparing the second statistical values with the first statistical values about each driver. The second statistical values are calculated by the individual-difference learning device 4213 in response to detection of the possibility of a driver change and temporarily stored in the volatile statistic table 4332 included in the learning data storage 433. The first statistical values are stored in the nonvolatile statistic table 4331 included in the learning data storage 433. The second statistical values are, for example, the average and the deviation for the retention direction of the face or gaze of the current driver. The first statistical values are, for example, the average and the deviation for the retention direction of the face or gaze of each driver. The driver state determiner 4214 causes the individual-difference learning device 4213 to calculate new first statistical values about the identified driver. The current driver may be determined to have no driver data stored in the nonvolatile statistic table 4331. In this case, the driver state determiner 4214 starts learning first statistical values about the new driver by causing the individual-difference learning device 4213 to calculate new first statistical values about the new driver.

The driver state determiner 4214 also reads the monitoring data from the monitoring data storage 431 in every predetermined period to determine the face or gaze direction of the driver. The driver state determiner 4214 also reads the first statistical values about the current driver for which the driver flag is set from the volatile statistic table 4332 included in the learning data storage 433. The driver state determiner 4214 further reads the vehicle information from the vehicle information storage 432, for example, the sensing data from the steering sensor 53 or the direction indicator sensor 54. Each time reading monitoring data and first statistical values, the driver state determiner 4214 corrects the face or gaze direction of the driver determined based on the monitoring data with a correction value included in the first statistical values, or more specifically, the average of the face or gaze direction of the driver. The driver state determiner 4214 then compares the corrected direction with a predetermined determination criterion value. This comparison allows the determination of the driver state, for example, whether the driver is engaging in distracted driving. The driver state determiner 4214 determines whether to determine the driver state or whether to output a determination result based on the sensing data from the steering sensor 53 or the direction indicator sensor 54. This is because an act of the driver for safety checking in rounding a curve on a road, turning right or left, or changing lanes may be similar to distracted driving and erroneously determined to be distracted driving.

The signal output unit 4215 outputs the driver state determination result information indicating the result of the driver state determination performed by the driver state determiner 4214 to the determination result output device 60 through the input-output interface unit 41.

### (4) Determination Result Output Device

The determination result output device 60 includes, for example, a speaker and an alert indicator lamp, and outputs the driver state determination result information output from the driver state determination apparatus 40 to the driver by emitting an alert sound or lighting the alert lamp. The determination result output device 60 may be one of the speaker and the alert indicator lamp. The determination result output device 60 may be implemented by a sound output function and an image display function of the navigation system included in the vehicle. The determination result output device 60 may be included in the driver state determination apparatus 40 and controlled by the signal output unit 4215.

### Operation

The operation of the driver state determination system with the above configuration will now be described.

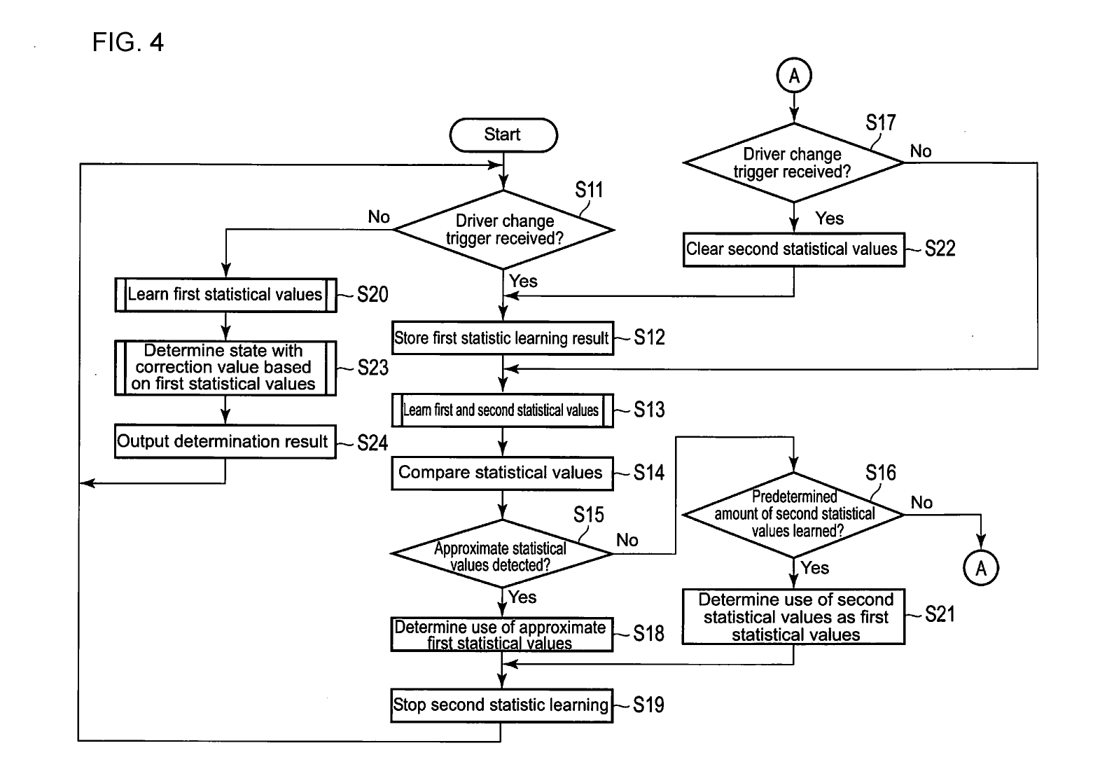

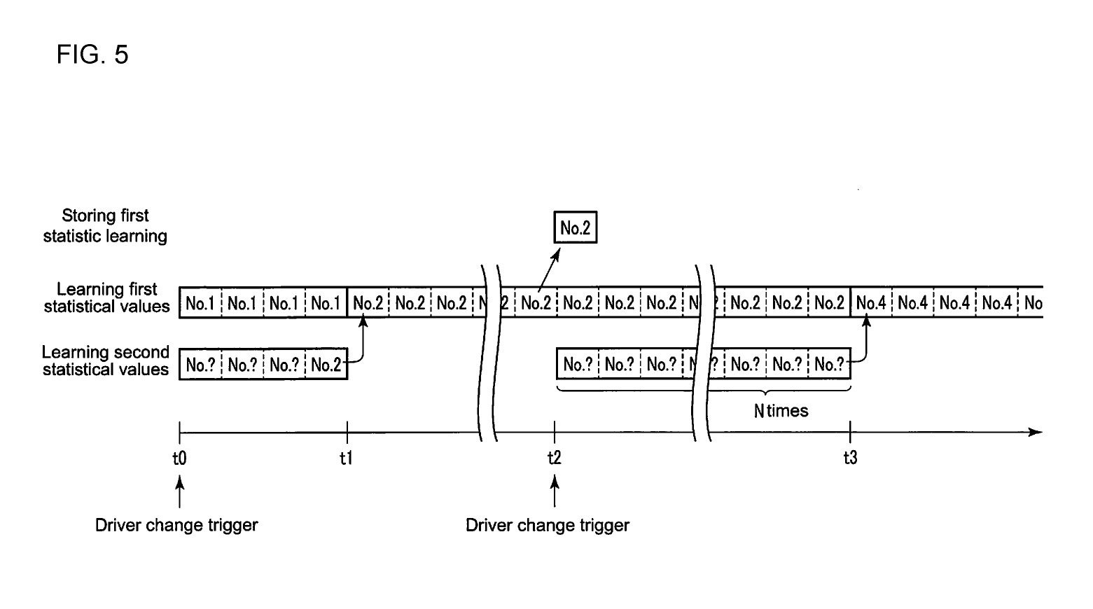

FIG. 4 is a flowchart showing the procedure and processing performed by the driver state determination system shown in FIG. 2. FIG. 5 is a time chart showing an example of statistic learning that follows the procedure in the driver state determination system shown in FIG. 2.

### (1) Receiving Sensing Data

When the vehicle power system is turned on, the driver state determination apparatus 40, the driver camera 51 serving as a driver monitoring sensor, and the sensors 52 to 56 serving as vehicle state sensors start operating. The driver state determination apparatus 40 uses the monitoring data obtaining unit 4211 to obtain sensing data from the driver camera 51 and store the sensing data into the monitoring data storage 431 as monitoring data. The driver state determination apparatus 40 also uses the vehicle information obtaining unit 4212 to obtain sensing data from each of the speed sensor 52, the steering sensor 53, the direction indicator sensor 54, the gear selector sensor 55, and the parking brake sensor 56 and store the sensing data into the vehicle information storage 432 as vehicle information. Sensing data is repeatedly obtained and stored until the vehicle power system is turned off.

### (2) Statistical Value Learning

### (2-1) No Driver Change

In the driver state determination apparatus 40, the individual-difference learning device 4213 starts learning first statistical values and second statistical values in parallel with the sensing data receiving operation.

More specifically, in step S11, the individual-difference learning device 4213 first determines whether a driver change trigger signal is received from the driver state determiner 4214. The vehicle driving source is turned on in the parking state, in which the vehicle is completely stopped. Thus, as shown in FIG. 5, at time t0 when the vehicle driving source is turned on, a driver change trigger signal is determined to be received from the driver state determiner 4214.

When receiving a driver change trigger signal, in step S12, the individual-difference learning device 4213 overwrites, as learning results, the first statistical values about the current driver, for which the driver flag is set in the nonvolatile statistic table 4331 included in the learning data storage 433, with the new first statistical values calculated immediately before receiving the driver change trigger signal and temporarily stored in the volatile statistic table 4332 included in the learning data storage 433. In the first processing of step S12 after the vehicle driving source is turned on, new first statistical values have not been calculated yet. Thus, no processing is performed in step S13. When receiving the second or any subsequent driver change trigger signal after the vehicle driving source is turned on, the new first statistical values are stored into the nonvolatile statistic table 4331 included in the learning data storage 433.

The individual-difference learning device 4213 then learns new first statistical values and second statistical values in step S13. In the first and second statistic learning, the individual-difference learning device 4213 calculates, in every predetermined period, the first and second statistical information during the predetermined period. In FIG. 5, dotted lines represent the boundaries between predetermined periods. For example, the same periods of time are used for the first statistic learning and the second statistic learning. In every predetermined period, the learning processing of step S13 stores new first statistical values and second statistical values into the volatile statistic table 4332 included in the learning data storage 433 to update the existing information in the table. More specifically, in the new first statistic learning, new first statistical values are calculated based on the last first statistical values stored in the volatile statistic table 4332 included in the learning data storage 433 and the statistical information such as the average and the deviation for the retention direction of the face or gaze of the current driver during the predetermined period determined by the driver state determiner 4214. In the first processing of step S13 after the vehicle driving source is turned on, the volatile statistic table 4332 included in the learning data storage 433 stores no previous first statistical values. Thus, the first statistical values about the driver before receiving the driver change trigger signal stored in the nonvolatile statistic table 4331 included in the learning data storage 433, or in other words, the first statistical values about the current driver indicated by the driver flag are temporarily stored in the volatile statistic table 4332 included in the learning data storage 433 for use. As shown in FIG. 5, the first statistic learning then starts for the driver identified by, for example, driver identifier 1. In the second statistic learning, second statistical values are calculated as statistical information such as the average and the deviation for the retention direction of the face or gaze of the current driver during the predetermined period determined by the driver state determiner 4214.

In every predetermined period described above, the individual-difference learning device 4213 compares, in step S14, the second statistical values temporarily stored in the volatile statistic table 4332 with the first statistical values about each driver stored in the nonvolatile statistic table 4331 included in the learning data storage 433. In step S15, the individual-difference learning device 4213 determines whether any first statistical values are approximate to the second statistical values. In the early stages of the second statistic learning, the statistical information tends to be unstable. When determining that no first statistical values are approximate to the second statistical values, the individual-difference learning device 4213 determines whether the second statistic learning has reached a predetermined amount (or N times) in step S16. The predetermined amount is a time period (or the number of times) sufficient for the statistical information to be stable. With the predetermined amount not reached by the second statistic learning, the individual-difference learning device 4213 determines whether a driver change trigger signal has been received from the driver state determiner 4214 in step S17. With no driver change trigger signal received, the driver state determination apparatus 40 learns first and second statistical values in step S13, and repeats the processing described above.

For example, with first statistical values approximate to the second statistical values, such approximate statistical values are detected in step S15. In this case, the individual-difference learning device 4213 determines the driver having the approximate first statistical values to be the driver currently driving the vehicle. More specifically, in step S19, the individual-difference learning device 4213 determines the approximate first statistical values to be the first statistical values for the driver state determination processing in the driver state determiner 4214, or in other words, the first statistical values to be learned. The individual-difference learning device 4213 then resets the driver flag in the nonvolatile statistic table 4331 to the driver having the determined first statistical values. However, the driver flag in the nonvolatile statistic table 4331 may have already been set at the driver having the determined first statistical values. In this case, no driver has been replaced, and thus the flag needs no resetting. In step S19, the individual-difference learning device 4213 then stops the second statistic learning and repeats the processing in step S11 and subsequent steps.

Returning to step S11, when determining that no driver change trigger signal has been received from the driver state determiner 4214, the individual-difference learning device 4213 learns new first statistical values in step S20.

### (2-2) Driver Change to Known Driver

For example, with first statistical values (driver number, 2; average, +5.0°; deviation, 1.0°) approximate to the second statistical values (average, +4.8° ; deviation, 1.4°) as shown in FIG. 3B, such approximate statistical values are detected in step S15 at time t1 in FIG. 5. In this case, the individual-difference learning device 4213 determines the driver having the approximate first statistical values to be the driver currently driving the vehicle. More specifically, in step S21, the individual-difference learning device 4213 determines the approximate first statistical values to be the first statistical values for the driver state determination processing performed by the driver state determiner 4214, or in other words, the first statistical values to be learned. The individual-difference learning device 4213 then resets the driver flag in the nonvolatile statistic table 4331 to the driver having the determined first statistical values. In step S19, the individual-difference learning device 4213 then stops the second statistic learning and repeats the processing in step S11 and subsequent steps.

When the processing advances from step S11 to step S20, new first statistical values are learned. In this example, the determined first statistical values, for example, new first statistical values about the driver identified by driver identifier 2, are learned. The second statistical values temporarily stored in the volatile statistic table 4332 may also be used for the new first statistic learning.

### (2-3) Driver Change to New Driver

In other cases, the second statistic learning may be determined to have reached the predetermined amount (N times) in step S16 with no approximate first statistical values found.

When, for example, a driver change trigger signal is received at time t2 in FIG. 5, the signal is detected in step S11. In step S12, the individual-difference learning device 4213 overwrites, as learning results, the first statistical values about the current driver in the nonvolatile statistic table 4331 included in the learning data storage 433 with the new first statistical values calculated immediately before receiving the driver change trigger signal and temporarily stored in the volatile statistic table 4332 included in the learning data storage 433. In this example, the new first statistical values about the current driver with driver number 2 are read from the volatile statistic table 4332. The first statistical values about the driver identified by driver identifier 2 in the nonvolatile statistic table 4331 are then overwritten with the read new first statistical values. In step S13, first and second statistical values are learned. With no approximate statistical values found in the statistic comparison performed in subsequent step S14, the processing for first and second statistic learning for the driver with driver number 2 in step S13 then continues through steps S15 to S17.

In step S16, for example, when determining that the second statistic learning has reached the predetermined amount (N times) at time t3, the individual-difference learning device 4213 determines, in step S21, the second statistical values temporarily stored in the volatile statistic table 4332 to be the first statistical values for the driver state determination processing performed by the driver state determiner 4214, or in other words, the first statistical values to be learned. The individual-difference learning device 4213 then adds an area for a new driver to the nonvolatile statistic table 4331, and stores the second statistical values stored in the volatile statistic table 4332 into the added area as the first statistical values, together with the identifier identifying the new driver. The individual-difference learning device 4213 then resets the driver flag in the nonvolatile statistic table 4331 to the driver having the newly stored first statistical values.

When, for example, the second statistical values stored in the volatile statistic table 4332 are an average of +3.2° and a deviation of 1.3° as shown in FIG. 3C, the nonvolatile statistic table 4331 stores no approximate first statistical values. In this case, as shown in FIG. 3D, the second statistical values are newly stored in the nonvolatile statistic table 4331 as the first statistical values about the driver identified by driver identifier 4.

In step S19, the individual-difference learning device 4213 stops the second statistic learning and repeats the processing in step S11 and subsequent steps.

When the processing advances from step S11 to step S20, new first statistical values are learned. In this example, the determined first statistical values, for example, new first statistical values about the driver identified by driver identifier 4, are learned. This new learning may preferably use more data. Thus, the second statistical values temporarily stored in the volatile statistic table 4332 may also be used for the new first statistic learning.

(2-4) Receiving Driver Change Trigger Signal during Second Statistic Learning

When a new driver change trigger signal is received during the second statistic learning, or more specifically, before the second statistic learning reaches the predetermined amount (N times) in step S16, the signal is detected in step S17. In this case, the individual-difference learning device 4213 clears the second statistical values learned and temporarily stored in the volatile statistic table 4332 in step S22. The processing then advances to step S12, in which the individual-difference learning device 4213 overwrites, as learning results, the first statistical values about the current driver in the nonvolatile statistic table 4331 with the new first statistical values calculated immediately before receiving the driver change trigger signal and stored in the volatile statistic table 4332. The processing then advances to step S13 to start learning new first statistical values and new second statistical values.

### (2-5) Turning Vehicle Power System Off

Usually, the vehicle enters the parking state, in which the vehicle is completely stopped, before the vehicle power system is turned off. Thus, in step S11 or S17, a driver change trigger signal is detected, and in step S12, the first statistical values about the current driver in the nonvolatile statistic table 4331 are overwritten, as learning results, with the new first statistical values calculated immediately before receiving the driver change trigger signal and stored in the volatile statistic table 4332. When the vehicle power system is next turned on, the first statistical values about the current driver stored in the nonvolatile statistic table 4331 in a nonvolatile manner are read and used.

### (3) Determining Driver State

After new first statistical values are learned in step S20, the driver state determiner 4214 determines the driver state with a correction value based on the new first statistical values temporarily stored in the volatile statistic table 4332 included in the learning data storage 433 in step S23. More specifically, the face or gaze direction of the driver determined based on the monitoring data stored in the monitoring data storage 431 is corrected with the average of the retention direction of the face or gaze of the driver, which is a correction value included in the new first statistical values about the current driver being learned. The corrected face or gaze direction of the driver is compared with a predetermined determination criterion value to determine the driver state, for example, whether the driver is engaging in distracted driving.

In step S24, the driver state determiner 4214 causes the signal output unit 4215 to output the driver state determination result information indicating the result of the driver state determination to the determination result output device 60. The determination result output device 60 then provides the driver state determination result information to the driver as an alert sound or lighting of the alert lamp.

### Advantages and Effects of Embodiment

As described in detail above, the driver state determination apparatus 40 according to one embodiment uses the individual-difference learning device 4213 to calculate first statistical values corresponding to first statistical information about each driver, and stores the calculated first statistical values in the nonvolatile statistic table 4331 included in the learning data storage 433 together with the identifier identifying each driver. The individual-difference learning device 4213 similarly calculates second statistical values corresponding to second statistical information about the current driver. The individual-difference learning device 4213 compares the calculated second statistical values with the first statistical information stored in the nonvolatile statistic table 4331. When first statistical information approximate to the second statistical values is found in the nonvolatile statistic table 4331, the individual-difference learning device 4213 determines the current driver of the vehicle to be the driver associated with the approximate first statistical information.

More specifically, the individual-difference learning device 4213 compares the calculated second statistical values with the first statistical values about each driver stored in the nonvolatile statistic table 4331 included in the learning data storage 433, and this comparison enables the current driver to be identified as one of the registered drivers. Thus, the driver currently driving the vehicle having the first statistical values calculated in previous determination can be easily identified.

In the driver state determination apparatus 40, the driver state determiner 4214 determines the possibility of a driver change based on the first or second sensing data. When the driver state determiner 4214 detects the possibility of a driver change, the individual-difference learning device 4213 starts calculating second statistical values.

Thus, the possibility of a driver change can be easily determined based on the first or second sensing data. When the possibility of a driver change is detected, the second statistical values are calculated, and the individual-difference learning device 4213 determines the driver based on the calculation result. When the individual-difference learning device 4213 determines the current driver of the vehicle to be the driver associated with the approximate first statistical values, and further the driver associated with the approximate first statistical values is the same as the driver identified before the driver state determiner 4214 detects the possibility of a driver change, the individual-difference learning device 4213 determines that the driver has not been replaced. When the determined driver differs from the driver identified before the driver state determiner 4214 detects the possibility of a driver change, the individual-difference learning device 4213 determines that the previous driver has been replaced, and easily identifies the current driver as one of the drivers. Thus, any new driver who has replaced the previous driver can be readily identified immediately after the start of driving.

In the driver state determination apparatus 40, first statistical values approximate to the second statistical values may not be found after a predetermined number of second statistic calculations. In this case, the individual-difference learning device 4213 stores the calculated second statistical values into the nonvolatile statistic table 4331 included in the learning data storage 433 as first statistical values about a new driver.

Thus, the first statistical values about the new driver can be added to the nonvolatile statistic table 4331 included in the learning data storage 433. When the new driver drives the vehicle again, the driver can be readily identified.

In the driver state determination apparatus 40, the individual-difference learning device 4213 determines, based on the first sensing data, the retention direction in which the driver looking straight ahead retains the face or gaze with respect to the forward direction of the vehicle. The individual-difference learning device 4213 then calculates statistical information about the retention direction of the face or gaze of the driver, for example, the average and the deviation for the retention direction of the face or gaze of the driver as first and second statistical values.

Thus, the apparatus can easily determine the driver currently driving the vehicle based on the statistical information without complicated personal authentication processing such as face recognition, or a specific operation by the driver such as self-reporting of a driver change. With no personal authentication processing, this structure may eliminate the need for higher program security level.

In the driver state determination apparatus 40, the individual-difference learning device 4213 calculates new first statistical values based on the first statistical values stored in the nonvolatile statistic table 4331 included in the learning data storage 433 and the first sensing data. The driver state determiner 4214 determines the driver state, for example, whether the driver is engaging in distracted driving based on the first sensing data and the new first statistical values. The signal output unit 4215 causes the determination result output device 60 to output the determination result to the driver. When the driver determined by the individual-difference learning device 4213 is the same as the driver having the first statistics calculated by the individual-difference learning device 4213, the individual-difference learning device 4213 will continue to calculate new first statistical values.

In other words, when the driver associated with the new first statistical values calculated by the individual-difference learning device 4213 is the current driver, the new first statistic calculation continues. Thus, in the driver state determination apparatus 40, when the driver state determiner 4214 determines the driver state based on the first sensing data and the new first statistical values, the driver state may be determined using the accurate first statistical values that are also based on the first statistical values stored in the nonvolatile statistic table 4331 included in the learning data storage 433 about the driver associated with the new first statistical values.

In the driver state determination apparatus 40, when the driver determined by the individual-difference learning device 4213 differs from the driver having the first statistics calculated by the individual-difference learning device 4213, the individual-difference learning device 4213 will switch the target of the new first statistic calculation to the first statistical values about the determined driver stored in the nonvolatile statistic table 4331 included in the learning data storage 433.

The switching prevents the new first statistical values that have been calculated up until then from being used in driver state determination. This is because the new first statistical values that have been calculated up until then are based on the first statistical values about another driver stored in the nonvolatile statistic table 4331 included in the learning data storage 433, and thus are inappropriate for the current driver different from the driver associated with the new first statistical values calculated by the individual-difference learning device 4213. The individual-difference learning device 4213 thus switches the target of the new first statistic calculation to the first statistical values about the determined driver stored in the nonvolatile statistic table 4331 included in the learning data storage 433, and calculates new first statistical values about the current driver. The calculated accurate first statistical values can be used to determine the driver state.

The driver state determination apparatus 40 can determine the driver state using the first statistical values associated with each individual driver, and thus achieve accurate driver state determination irrespective of differences between individual drivers.

In the driver state determination apparatus 40, the driver state determiner 4214 determines the possibility of a driver change based on the first or second sensing data. When the driver state determiner 4214 detects the possibility of a driver change, the individual-difference learning device 4213 stores the new first statistical values that have been calculated up until then into the nonvolatile statistic table 4331 included in the learning data storage 433.

This allows the new first statistical values with their accuracy increased through repetitive calculations to be used for driver determination by the individual-difference learning device 4213.

In the driver state determination apparatus 40, first statistical values approximate to the second statistical values may not be found after a predetermined number of second statistic calculations. In this case, the second statistical values calculated by the individual-difference learning device 4213 are stored into the nonvolatile statistic table 4331 included in the learning data storage 433 as first statistical values about a new driver. The individual-difference learning device 4213 switches the target of the new first statistic calculation to the first statistical values about the new driver stored in the nonvolatile statistic table 4331 included in the learning data storage 433.

Thus, the first statistical values about the new driver can be added before the start of driver state determination. When the new driver drives the vehicle again, driver state determination appropriate for the new driver can be performed.

In the driver state determination apparatus 40, the individual-difference learning device 4213 calculates second statistical values in parallel with the new first statistic calculation by the individual-difference learning device 4213, and stops the second statistic calculation when the individual-difference learning device 4213 determines the current driver of the vehicle.

Thus, the individual-difference learning device 4213 can calculate second statistical values as appropriate.

### Modifications

The embodiments of the present invention described in detail above are mere examples of the present invention in all respects. The embodiments may be variously modified or altered without departing from the scope of the present invention. More specifically, the present invention may be implemented as appropriate using the configuration specific to each embodiment.

(1) In the above embodiment, for example, the driver state determiner 4214 determines the possibility of a driver change. In some embodiments, the individual-difference learning device 4213 may determine the possibility of a driver change based on monitoring data stored in the monitoring data storage 431 or vehicle information stored in the vehicle information storage 432. In other embodiments, a dedicated unit may be added as a driver-change possibility determiner. These modifications can also produce the same advantageous effects as in the above embodiment.

Additionally, the face or gaze direction of the driver may be detected by the monitoring data obtaining unit 4211 based on sensing data from the driver camera 51, and the detection result may be stored in the monitoring data storage 431.

(2) In the above embodiment, when the driver state is determined, the face or gaze direction of the driver determined based on the monitoring data stored in the monitoring data storage 431 is corrected with the average of the retention direction of the face or gaze of the driver, which is a correction value included in the first statistical values about the current driver being learned. The corrected face or gaze direction is compared with a predetermined determination criterion value to determine the driver state, for example, whether the driver is engaging in distracted driving. In other words, the determination criterion value is fixed, and the face or gaze direction of the driver is corrected based on a correction value included in the new first statistical values, and the driver state is determined by comparing the fixed determination criterion value and the corrected direction. Conversely, the determination criterion value may be corrected based on a correction value, and the driver state may be determined by comparing the corrected criterion value and the face or gaze direction of the driver. This modification also produces the same advantageous effects as in the above embodiment.

The present invention is not limited to the embodiments described above, but the components may be modified without departing from the spirit and scope of the invention. The components described in the above embodiments may be combined as appropriate to provide various aspects of the invention. For example, some of the components described in each embodiment described above may be eliminated. Further, components in different embodiments may be combined as appropriate.

### Appendixes

The embodiments described above may be partially or entirely expressed in, but not limited to, the following forms shown in the appendixes below.

### Appendix 1

A driver determination apparatus (10), comprising:

a first calculator (15) configured to calculate first statistical information based on first sensing data output from a first sensor (21) and including an image of a driver of a vehicle, the first statistical information being statistical information about a retention direction in which the driver looking straight ahead retains a face or a gaze with respect to a forward direction of the vehicle;

a storage (16) configured to store the calculated first statistical information with an identifier associated with the driver; and

a first determiner (17) configured to compare the first statistical information stored in the storage with second statistical information calculated by the first calculator based on first sensing data output from the first sensor and including an image of a current driver of the vehicle, the second statistical information being statistical information about the retention direction for the current vehicle driver, and

to determine, when finding first statistical information approximate to the second statistical information in the storage, the current vehicle driver as a driver associated with the approximate first statistical information.

### Appendix 2

A driver state determination apparatus (30), comprising:

the driver determination apparatus according to Appendix 1;

a second calculator (31) configured to calculate new first statistical information based on the first statistical information stored in the storage and the first sensing data;

a third determiner (32) configured to determine a state of the driver based on the first sensing data and the new first statistical information calculated by the second calculator; and

an output unit (33) configured to output a determination result from the third determiner to the driver,

wherein when a driver determined by the first determiner is identical to a driver having the first statistical information calculated by the second calculator, the second calculator continues the new first statistical information calculation, and

when the driver determined by the first determiner differs from the driver having the first statistical information calculated by the second calculator, the second calculator switches a target of the new first statistical information calculation to the first statistical information about the determined driver stored in the storage.

### Appendix 3

A driver determination method implemented by a driver determination apparatus (10) for determining a driver, the method comprising:

calculating, with the driver determination apparatus, first statistical information based on first sensing data output from a first sensor (21) and including an image of a driver of a vehicle, the first statistical information being statistical information about a retention direction in which the driver looking straight ahead retains a face or a gaze with respect to a forward direction of the vehicle;

storing, with the driver determination apparatus, the calculated first statistical information with an identifier associated with the driver;

calculating, with the driver determination apparatus, second statistical information based on first sensing data output from the first sensor and including an image of a current driver of the vehicle, the second statistical information being statistical information about the retention direction for the current vehicle driver; and

comparing, with the driver determination apparatus, the calculated second statistical information with the stored first statistical information, and when first statistical information approximate to the second statistical information is stored, determining the current vehicle driver as a driver associated with the approximate first statistical information.

### Appendix 4

A driver state determination method implemented by a driver state determination apparatus (30) that uses the driver determination method according to Appendix 3, the driver state determination method comprising:

calculating, with the driver state determination apparatus, new first statistical information based on the stored first statistical information and the first sensing data;

determining, with the driver state determination apparatus, a state of the driver based on the calculated new first statistical information; and

outputting, with the driver state determination apparatus, a determination result of the driver state to the driver,

wherein when a driver determined in determining the current vehicle driver as the driver associated with the approximate first statistical information is identical to a driver having the new first statistical information calculated, calculating the new first statistical information includes continuing the new first statistical information calculation, and

when the determined driver differs from the driver having the new first statistical information calculated, calculating the new first statistical information includes switching a target of the new first statistical information calculation to the stored first statistical information about the determined driver.

### Appendix 5

A driver determination apparatus comprising a hardware processor (421) and a memory (43), the hardware processor being configured to

calculate first statistical information based on first sensing data output from a first sensor (51) and including an image of a driver of a vehicle, the first statistical information being statistical information about a retention direction in which the driver looking straight ahead retains a face or a gaze with respect to a forward direction of the vehicle;

store the calculated first statistical information with an identifier associated with the driver in the memory;

calculate second statistical information based on first sensing data output from the first sensor and including an image of a current driver of the vehicle, the second statistical information being statistical information about the retention direction for the current vehicle driver; and

compare the calculated second statistical information with the first statistical information stored in the memory, and when first statistical information approximate to the second statistical information is stored, determine the current vehicle driver as a driver associated with the approximate first statistical information.

### Appendix 6

A driver state determination apparatus comprising a hardware processor (421) and a memory (43), the hardware processor being configured to

perform the operations of the driver determination apparatus according to Appendix 5;

calculate new first statistical information based on the stored first statistical information and the first sensing data;

determine a state of the driver based on the first sensing data and the calculated new first statistical information; and

output a determination result of a driver state to the driver,

wherein when a driver determined in determining the current vehicle driver as the driver associated with the approximate first statistical information is identical to a driver having the new first statistical information calculated, calculating the new first statistical information includes continuing the new first statistical information calculation, and

when the determined driver differs from the driver having the new first statistical information calculated, calculating the new first statistical information includes switching a target of the new first statistical information calculation to the first statistical information about the determined driver stored in the memory.

### Appendix 7

A driver determination method implemented by an apparatus including a hardware processor (421) and a memory (43), the method comprising:

calculating, with the hardware processor, first statistical information based on first sensing data output from a first sensor (51) and including an image of a driver of a vehicle, the first statistical information being statistical information about a retention direction in which the driver looking straight ahead retains a face or a gaze with respect to a forward direction of the vehicle;

storing, with the hardware processor, the calculated first statistical information with an identifier associated with the driver in the memory;

calculating, with the hardware processor, second statistical information based on first sensing data output from the first sensor and including an image of a current driver of the vehicle, the second statistical information being statistical information about the retention direction for the current vehicle driver; and

comparing, with the hardware processor, the calculated second statistical information with the first statistical information stored in the memory, and when first statistical information approximate to the second statistical information is stored, determining the current vehicle driver as a driver associated with the approximate first statistical information.

### Appendix 8

A driver state determination method implemented by an apparatus including a hardware processor (421) and a memory (43), the method comprising:

in addition to the processes included in the driver determination method according to Appendix 7,

calculating, with the hardware processor, new first statistical information based on the first statistical information stored in the memory and the first sensing data;

determining, with the hardware processor, a state of the driver based on the first sensing data and the calculated new first statistical information; and

outputting, with the hardware processor, a determination result of the driver state to the driver,

wherein when a driver determined in determining the current vehicle driver as the driver associated with the approximate first statistical information is identical to a driver having the new first statistical information calculated, calculating the new first statistical information includes continuing the new first statistical information calculation, and

when the determined driver differs from the driver having the new first statistical information calculated, calculating the new first statistical information includes switching a target of the new first statistical information calculation to the first statistical information about the determined driver stored in the memory.

1. A driver determination apparatus, comprising:
a first calculator configured to calculate first statistical information based on first sensing data output from a first sensor and including an image of a driver of a vehicle, the first statistical information being statistical information about a retention direction in which the driver looking straight ahead retains a face or a gaze with respect to a forward direction of the vehicle;
a storage configured to store the calculated first statistical information with an identifier associated with the driver; and
a first determiner configured to compare the first statistical information stored in the storage with second statistical information calculated by the first calculator based on first sensing data output from the first sensor and including an image of a current driver of the vehicle, the second statistical information being statistical information about the retention direction for the current vehicle driver, and
to determine, when finding first statistical information approximate to the second statistical information in the storage, the current vehicle driver as a driver associated with the approximate first statistical information.

2. The driver determination apparatus according to claim 1, further comprising:
a second determiner configured to determine a possibility of a change of the current vehicle driver based on the first sensing data or second sensing data, the second sensing data being output from a second sensor and indicating a vehicle state,
wherein the first calculator starts calculating the second statistical information when the second determiner detects a possibility of a driver change.

3. The driver determination apparatus according to claim 2, wherein
when finding no first statistical information approximate to the second statistical information after a predetermined number of second statistical information calculations performed by the first calculator, the first determiner stores the second statistical information into the storage as first statistical information associated with a new driver.

4. The driver determination apparatus according to claim 2, wherein
the first calculator determines the retention direction of the driver based on the first sensing data, and
the first statistical information and the second statistical information are averages and deviations of the determined retention direction during a predetermined period.

5. The driver determination apparatus according to claim 1, wherein
when finding no first statistical information approximate to the second statistical information after a predetermined number of second statistical information calculations performed by the first calculator, the first determiner stores the second statistical information into the storage as first statistical information associated with a new driver.

6. The driver determination apparatus according to claim 5, wherein
the first calculator determines the retention direction of the driver based on the first sensing data, and
the first statistical information and the second statistical information are averages and deviations of the determined retention direction during a predetermined period.

7. The driver determination apparatus according to claim 1, wherein
the first calculator determines the retention direction of the driver based on the first sensing data, and
the first statistical information and the second statistical information are averages and deviations of the determined retention direction during a predetermined period.

8. A driver state determination apparatus, comprising:
the driver determination apparatus according to claim 1;
a second calculator configured to calculate new first statistical information based on the first statistical information stored in the storage and the first sensing data;
a third determiner configured to determine a state of the driver based on the first sensing data and the new first statistical information calculated by the second calculator; and
an output unit configured to output a determination result from the third determiner to the driver,
wherein when a driver determined by the first determiner is identical to a driver having the first statistical information calculated by the second calculator, the second calculator continues the new first statistical information calculation, and
when the driver determined by the first determiner differs from the driver having the first statistical information calculated by the second calculator, the second calculator switches a target of the new first statistical information calculation to the first statistical information about the determined driver stored in the storage.

9. The driver state determination apparatus according to claim 8, wherein
the driver determination apparatus further includes a second determiner configured to determine a possibility of a change of the current vehicle driver based on the first sensing data or second sensing data, the second sensing data being output from a second sensor and indicating a vehicle state,
the first calculator starts calculating the second statistical information when the second determiner detects a possibility of a driver change, and
the second calculator stores the new first statistical information into the storage when the second determiner detects a possibility of a driver change.

10. The driver state determination apparatus according to claim 9, wherein
when the first determiner finds no first statistical information approximate to the second statistical information after a predetermined number of second statistical information calculations performed by the first calculator, the first calculator stores the second statistical information into the storage as first statistical information associated with a new driver, and stops the second statistical information calculation, and
the second calculator switches a target of the new first statistical information calculation to the first statistical information about the new driver stored into the storage by the first calculator.

11. The driver state determination apparatus according to claim 9, wherein
the first calculator calculates the second statistical information in parallel with the new first statistical information calculation performed by the second calculator, and
the first calculator stops the second statistical information calculation when the first determiner determines the current vehicle driver as a driver associated with the approximate first statistical information.

12. The driver state determination apparatus according to claim 8, wherein
when the first determiner finds no first statistical information approximate to the second statistical information after a predetermined number of second statistical information calculations performed by the first calculator, the first calculator stores the second statistical information into the storage as first statistical information associated with a new driver, and stops the second statistical information calculation, and
the second calculator switches a target of the new first statistical information calculation to the first statistical information about the new driver stored into the storage by the first calculator.

13. The driver state determination apparatus according to claim 12, wherein
the first calculator calculates the second statistical information in parallel with the new first statistical information calculation performed by the second calculator, and
the first calculator stops the second statistical information calculation when the first determiner determines the current vehicle driver as a driver associated with the approximate first statistical information.

14. The driver state determination apparatus according to claim 8, wherein
the first calculator calculates the second statistical information in parallel with the new first statistical information calculation performed by the second calculator, and
the first calculator stops the second statistical information calculation when the first determiner determines the current vehicle driver as a driver associated with the approximate first statistical information.

15. A driver determination method implemented by a driver determination apparatus for determining a driver, the method comprising:
calculating, with the driver determination apparatus, first statistical information based on first sensing data output from a first sensor and including an image of a driver of a vehicle, the first statistical information being statistical information about a retention direction in which the driver looking straight ahead retains a face or a gaze with respect to a forward direction of the vehicle;
storing, with the driver determination apparatus, the calculated first statistical information with an identifier associated with the driver;
calculating, with the driver determination apparatus, second statistical information based on first sensing data output from the first sensor and including an image of a current driver of the vehicle, the second statistical information being statistical information about the retention direction for the current vehicle driver; and
comparing, with the driver determination apparatus, the calculated second statistical information with the stored first statistical information, and when first statistical information approximate to the second statistical information is stored, determining the current vehicle driver as a driver associated with the approximate first statistical information.

16. A driver state determination method implemented by a driver state determination apparatus, the driver state determination method including the driver determination method according to claim 15, the driver state determination method comprising:
calculating, with the driver state determination apparatus, new first statistical information based on the stored first statistical information and the first sensing data;
determining, with the driver state determination apparatus, a state of the driver based on the calculated new first statistical information; and
outputting, with the driver state determination apparatus, a determination result of the driver state to the driver,
wherein when a driver determined in determining the current vehicle driver as the driver associated with the approximate first statistical information is identical to a driver having the new first statistical information calculated, calculating the new first statistical information includes continuing the new first statistical information calculation, and
when the determined driver differs from the driver having the new first statistical information calculated, calculating the new first statistical information includes switching a target of the new first statistical information calculation to the stored first statistical information about the determined driver.

17. A non-transitory recording medium having a driver determination program recorded thereon, the driver determination program causing a computer to function as the units included in the driver determination apparatus according to claim 1.

18. A non-transitory recording medium having a driver state determination program recorded thereon, the driver state determination program causing a computer to function as the units included in the driver state determination apparatus according to claim 8.
